(19) United States
(12) Patent Application Publication
(10) Pub. No.: US 2025/0347210 A1
(43) Pub. Date: Nov. 13, 2025

(54) HYDROGEN ECOSYSTEM FOR UPSTREAM OIL PRODUCTION

(71) Applicant: CONOCOPHILLIPS COMPANY, Houston, TX (US)

(72) Inventors: Jose Luis CHAVARRIA GUERRA, Houston, TX (US); Ramesh SHARMA, Houston, TX (US)

(73) Assignee: CONOCOPHILLIPS COMPANY, Houston, TX (US)

(21) Appl. No.: 19/171,877

(22) Filed: Apr. 7, 2025

Related U.S. Application Data
(60) Provisional application No. 63/644,564, filed on May 9, 2024.

(51) Int. Cl. E21B 43/16; C25B 1/04; C25B 9/19; C25B 9/70; E21B 43/24; E21B 43/26; H02K 7/18

(52) U.S. Cl. CPC E21B 43/168; C25B 1/04; C25B 9/19; C25B 9/70; E21B 43/2401; E21B 43/26; H02K 7/18

(57) ABSTRACT

A hydrogen ecosystem for producing oil and gas is described, where land local to an oil field hosts each of the following components: one or more producing oil wells, one or more non-producing oil wells, and optionally one or more new wells; a wind farm or a solar farm, or both, for generating electricity; said wind farm or a solar farm, or both, electrically connected to an electrolyzer for converting water to hydrogen; said electrolyzer fluidly connected to a compressor for producing compressed hydrogen; said compressor fluidly connected to a high pressure injection line for injecting said compressed hydrogen into a hydrogen storage well (HSW), said hydrogen storage well being a non-producing well that has been plugged and fitted for hydrogen storage; said HSW fluidly connected to a pressure reducing regulator for producing uncompressed hydrogen; said pressure reducing regulator fluidly connected to a pipeline for delivering said uncompressed hydrogen to a hydrogen power unit for converting said uncompressed hydrogen to electricity; said electricity electrically connected to oil production equipment for producing hydrocarbons from said oil field.

### PRIOR RELATED APPLICATIONS

This application claims priority to U.S. Ser. No. 63/644,564, filed May 9, 2024, and incorporated by reference in its entirety for all purposes.

### FEDERALLY SPONSORED RESEARCH STATEMENT

Not applicable.

### REFERENCE TO MICROFICHE APPENDIX

Not applicable.

### FIELD OF THE DISCLOSURE

This invention relates generally to a net zero hydrogen ecosystem providing on-site clean power for oil production.

### BACKGROUND OF THE DISCLOSURE

Oil production can be a very energy intensive process. Hydraulic fracturing (“fracking”) requires energy to pump fluids at pressures high enough to fracture the reservoir. Heavy oil and bitumens may be steam heated to thin them enough for production, and significant energy is required to turn water into steam. Additional energy is needed to bring the oil to the surface once the natural drive has diminished, and to separate the produced oil, gas, and water, clean the produced water and transport the products to the refineries.

Due to the transient and often geographically remote nature of oil production, the more permanent measures offered by grid based electrical utilities cannot be economically justified in many cases. Without a grid infrastructure in many remote plays, oil field operators currently rely on different types of generators, including internal combustion engines (ICE), turbines, centrifugal generators, diesel, propane, or gasoline-powered generators for electricity at costs up to 28¢/kWh. Even where there is a nearby grid, the power demands of operations such as fracturing are too high for the grid to supply and may only be used for short periods of time before moving to subsequent fracturing locations. Because these fossil fuel powered options are economically unfavorable and also contribute to global warming, there is a need for portable, clean and cost-effective energy sources.

Operators have thus attempted to develop on-site power generation without burning fossil fuels. One such option has been to harness the use of geothermal power, a potentially attractive option where there are already existing wells to reach the thermal resources deep underground. Geothermal's key strength lies in it not being intermittent, but instead providing a continuous baseload of energy. Indeed, ConocoPhillips Company has made some advancements in this area (see e.g., U.S. Ser. No. 12/066,012). However, potential drawbacks include higher development costs and risks associated with project development, which can at times make it difficult for projects to progress past the approval or test stage.

While major E&P players and oilfield service companies have dabbled in geothermal energy for decades, the need for diversification and pursuit of clean energy sources has never been more pressing.

Thus, what is needed in the art are other energy sources that can be provided locally to remote sites in a cost-effective manner. Power sources need to be continuous, not intermittent like wind and solar, and preferably not contribute any CO₂, methane, or other greenhouse gases to the environment. This disclosure meets one or more of those needs.

### SUMMARY OF THE DISCLOSURE

The invention herein is a hydrogen ecosystem that can be set up at remote oil reservoirs and provide continuous clean energy for use in producing oil and gas. The technology required to use hydrogen for producing power is currently available and continues to be developed, but adoption in upstream oil production has been severely limited, due in part to the lack of low-cost H₂ availability on-site that would make its use economically attractive. The presented system leverages existing infrastructure and land already part of upstream production operations to create a fully interconnected system to generate low-cost hydrogen to incentivize its use during steam generation, hydraulic fracturing, and other oil and gas producing operations. Such systems are sometimes called Power-to-Hydrogen-to-Power (P2H2P) systems-conversion of power to hydrogen, its storage, transport, and re-electrification.

In our ecosystem, intermittent clean power (e.g., wind and solar) are used to provide electricity to drive an electrolyzer, which then produces low-cost clean H₂ and O₂. The H₂ is used and/or stored in suitable nonproductive wells as needed for subsequent electricity generation. Since the intermittent clean power is used on site or very nearby, there are little to no losses during transmission, and since the H₂ is also stored and used on site or very nearby, there are few losses due to leakage and minimized transport cost.

Green hydrogen from electrolysis of water using clean energy sources addresses the variability of renewable energy output. Producing green hydrogen can both reduce the need for renewable power curtailment during periods of high renewables output and be stored long-term to provide for power generation during periods of low or zero output. Essentially, the hydrogen acts as a storage battery for the wind and solar energy, available on demand.

Preferably, both wind and solar are used, as most plays have sufficient space for both, and wind tends to be higher at night, while solar is only available during the day. Thus, combining the two provides more continuous hydrogen generation. However, any clean energy resource could be used. Clean hydrogen may also be produced elsewhere and stored onsite until needed. The ability to store large quantities of hydrogen within the operated area, provides a local reservoir that can be utilized rapidly for fracturing and then slowly restored during periods between fracturing stages.

Although molecular hydrogen has very high energy density on a mass basis, as a gas at ambient conditions it has very low energy density by volume partly because of its low molecular weight. Therefore, to be used as fuel, pure hydrogen gas is stored in an energy-dense form. Increasing gas pressure improves the energy density by volume making for smaller container tanks. The energy cost of compressing hydrogen at high pressures is significant but can also be provided by the wind and solar generators (or even the hydrogen generators). A way to store H₂ is key because on-demand H₂ decouples H₂ production (slow and steady) from fracturing use (large scale and rapid).

Another issue to address is leakage. Because hydrogen is the smallest molecule, it easily escapes from containers, and leaked hydrogen has a global warming effect 11.6 times stronger than CO₂. Thus, few materials are suitable for tanks as hydrogen tends to diffuse through many polymeric materials. Tanks made of carbon and glass fiber reinforcing plastic are required to meet automobile safety standards, but the standard material for holding pressurized hydrogen in tube trailers is steel. There is no hydrogen embrittlement problem for steel exposed to high pressure hydrogen gas. Thus, the steel pipes used to case wells and build pipelines are well suited for storing and transporting hydrogen, and with local generation and storage, there is less opportunity for leakage as compared with long distance pipelines or overland/oversea transport. Indeed, hydrogen gas piping is routine in large oil-refineries, because hydrogen is used to hydrocrack fuels from crude oil.

Hydrogen can then be converted back into useful forms of energy in a hydrogen-to-power unit, which can operate in any of several different ways already available, plus new methods that continue to be developed. Some of hydrogen conversion technologies are unique to hydrogen, but all of them are more efficient and less polluting than conversion of conventional fuels. Hydrogen's end use does not produce any pollutants (except some NOx if hydrogen is burned with air) or any other harmful effects on the environment. For example, hydrogen combusted with pure oxygen results in pure steam as shown in Equation 1:

$$2 {H}_{2} + {O}_{2} \to 2 {H}_{2} O . \qquad Eq . l$$

One hydrogen-to-power unit is a H₂ generator. Burning H₂ instead of diesel would reduce emissions to near zero, thus providing a better source of electricity. Hydraulic fracturing (“fracking”) uses about 1500 horsepower of energy too much for the grid-plus it is high voltage, high current and must be generated onsite. By replacing diesel with H₂ for power generation, we can dramatically reduce our greenhouse gas footprint. The H₂ can thus be burned in a 30-50 MWatt generator. It requires stores of H₂ to keep it running during fracking operations, but there is typically time to replenish the H₂ before the next fracking operation or other high energy oilfield operation.

Preferred H2P units are fuel cells, which dramatically increasing efficiency of hydrogen generation. A fuel cell is an electrochemical cell that converts the chemical energy of a fuel (often hydrogen) and an oxidizing agent (often oxygen) into electricity through a pair of redox reactions. Fuel cells are different from most batteries in requiring a continuous source of fuel and oxygen (usually from air) to sustain the chemical reaction, whereas in a battery the chemical energy usually comes from substances that are already present in the battery. Fuel cells can produce electricity continuously for as long as fuel and oxygen are supplied. Although fuel cells are preferred herein, any H2P unit could be used.

The various components together make up a hydrogen ecosystem that is particularly suited for use on or near oil reservoirs, particularly remote reservoirs, such as the Permian basin, where wind, sun and land are plentiful, the Powder River or Easter Great basins where wind is reliable and land available or any reservoir with sufficient space and existing production infrastructure.

The main elements of the hydrogen ecosystem include at least a hydrogen storage well and a hydrogen-to-power unit suitably located near oil production operations along with all suitable connections, however, additional elements may be added as suitable for the site, and these elements are selected from one or more of the following:

### 1. Space for Renewable Energy Generation and Use to Make H₂

Many onshore assets, especially unconventional oil plays, are operated within extensive and remote land areas that can be utilized to generate either solar or wind power (or both) that can be used to produce hydrogen without interfering with normal operations or invoking community backlash.

The solar/wind power is used, preferably locally but not necessarily, to run electrolyzers, which split water to generate hydrogen, but intermittent power sources are available. The modular and scalable design of electrolyzers also allows for generating hydrogen in relatively small clusters close to where power is generated in order to minimize transmission losses. The hydrogen is then used immediately or stored for use when wind and sun are not available.

Certain oil basins, such as the Permian basin, are close to extensive commercial wind farms, in which case the wind power may be purchased locally, and the infrastructure costs to build wind farms avoided. There may also be instances where H₂ can be brought in locally, but if not green hydrogen, and most hydrogen in the US is not green, then the emission savings are lost or at least reduced.

Although wind and solar may be suited for some reservoirs, e.g., in West Texas, the electrolyzer can use any clean electricity from e.g., hydroelectric, solar, nuclear, wind power, wave power, geothermal, clean hydrogen or combinations thereof to split water.

### 2. Dynamic Storage of H₂ in Temporary Abandoned Wells

During an asset life cycle, many non-productive wells fall below the economic threshold for continued oil production and are temporarily shut-in or abandoned until the economics of oil production changes. These wells often co-exist with producing wells and provide an excellent resource for hydrogen storage.

There are different types of abatement for non- or less-productive wells.

Shut-in—The well is closed by closing all valves when it is no longer economical and reopened when economy improves. Here the well must be constantly monitored for pressure changes.

Temporary Abandonment—In a temporary abandonment, a short section downhole is plugged, typically with a bridge plug or with cement near the top of the reservoir, and valves remain at the top to close the well. The bridge plug can be pulled out or the cement can be re-drilled to reopen it. The temporary abandoned wells also need to be monitored for pressure changes.

Abandonment-A cement or other plug of many feet in length is placed in reservoir, the Christmas tree removed, and the top of the well is welded permanently shut for permanent abandonment. Once a wellhead is removed and the well is welded, it is not possible to reopen.

Herein we propose a new type of abandonment—H₂ abandonment—also called a “Hydrogen Storage Well” or HSW herein. In this type of well closure, we place a cement plug at the reservoir level, but the cap is not welded shut. The H₂ storage volume is thus from the top of the reservoir to the surface and this vertical section of well can store hydrogen at relatively high pressures while remaining within well integrity limits. The well is fitted with pressure control systems, as well as hydrogen storage and delivery hardware, or the existing hardware repurposed for same. The Christmas tree remains accessible, and the well is tested for adequate isolation, typically by a pressure test and continuous pressure monitoring. Since the H₂ is stored above the reservoir, it remains uncontaminated with reservoir fluids and remains a clean energy source.

The hydrogen storage wells can be situated all over a given field and be interconnected through a hydrogen pipeline network. To keep the pipeline pressures low (below spec limit) while storing hydrogen in wells at high pressure, H₂ compressor skids on the pad will compress and inject high pressure hydrogen during “storage mode”.

Pressure reducing regulators are then used to maintain constant delivery of hydrogen to the low-pressure pipeline network during “delivery mode”. The combination of some wells in “storage mode” and others in “delivery mode” interconnected to the H₂ pipeline network provides a dynamic system that can both deliver and store hydrogen on demand. Further, since everything is reasonably local (e.g. within a play, reservoir, or basin), transmission losses of either electricity or hydrogen are minimized.

### 3. Repurpose Pipelines for Low-Cost Local Transport of H₂

In the presented system where supply (hydrogen generation) and demand (e.g., steam generation or fracking operations) are occurring in a relatively small area, the use of existing pipeline for hydrogen transport is an ideal low-cost option for hydrogen transport. To minimize investment costs, it is possible to repurpose many existing production pipelines to create a hydrogen pipeline network.

The main opportunities for repurposing pipelines include:
3.1. Existing production pipelines from non-productive pads (now repurposed as H₂ storage wells) are converted to hydrogen pipelines. In some stances the pipes will need cleaning before use, but this can be done with existing technology, such as chemical washing and/or running a pig down the line.
3.2. Production pipelines from new pads can be used to deliver H₂ during steam stimulation or fracking operations before they are used for oil production. Since these have not yet been used for oil, they will be clean and ready to transport hydrogen without contamination.
3.3. New H₂ pipeline network can also be developed parallel to existing production pipelines and thereby share some existing infrastructure (e.g. right of path, supports, trenches, etc.). Gas lines are typically much smaller than production lines, and can be easily laid alongside larger production lines using their rights-of-way. The ability to repurpose existing support systems, rights of way, etc., greatly saves on the infrastructure costs of installing any new hydrogen pipeline components (e.g., from electrolyzers to either storage wells or to where a new pipeline can T into existing pipelines).

Where new pipeline must be laid, it may be preferred to use fiber reinforced polymer (FRP) pipelines for hydrogen distribution. The installation costs for FRP pipelines are about 20% less than that of steel pipelines because the FRP can be obtained in sections that are much longer than steel, minimizing welding requirements. The use of FRP further improves the economics of the hydrogen ecosystem.

In other embodiments, austenitic stainless steel, aluminum, low-alloy ferritic steels, C—Mn ferritic steel, or copper alloy tubing may be utilized due to its small size and ease of installation.

### 4. Hydrogen to Electricity Conversion

The H₂ can be converted back into electricity with any hydrogen generator when needed because the intermittent clean energy sources are not available. As noted above, one may use hydrogen turbine generators, hydrogen steam generators, catalytic burners, reverse electrolysis and/or fuel cells. These H2P units are also locally located, and the power can be used anywhere in oil production operations, and if steam is generated, it can be used downhole or for the electrolyzer, or anywhere steam is needed.

In other embodiments, the hydrogen may be combined with natural gas, and the combined fuel fed into turbine combusters. While not as useful as 100% hydrogen systems, such hybrid system may prove useful as an intermediate step while on the conversion to 100% clean fuels. In such cases, natural gas or other light end hydrocarbons produced on site may be fed with the hydrogen into a combuster unit.

### 5. Water Treatment Facilities

It is also possible to take advantage of efforts to treat production water and use it as input for electrolyzers. If efforts to treat water are already undergoing, the beneficial use of treated water for clean hydrogen generation may be preferred over purchasing clean water. Optimization of technology may be needed, however, to use this relatively dirty water source, and minimize fouling of electrodes in the electrolyzer. Steam generated during hydrogen conversion to electricity may also be a good source of clean water for the electrolyzer.

### 6. Steam Generation

If a local, compact hydrogen/oxygen steam generator is used to convert the hydrogen into electricity and steam, the steam can be injected downhole in various enhanced oil recovery methods, such as cyclic steam generation (CSG) or steam assisted gravity drainage (SAGD), which would be especially beneficial in unconventional plays, such as Athabasca oil sands or Bakken shale. In addition, steam can also be used to generate electricity or provide power to various devices, or even provide clean water for the electrolyzer.

Thus, the “hydrogen ecosystem” for upstream production operations presents a new type of framework to think about hydrogen generation and use as part of an interconnected system to lower supply cost and demand uncertainty. This is possible because upstream production operations have many sharable system components with the hydrogen ecosystem.

Particularly novel is the use of H₂-style abandoned wells for dynamic hydrogen storage and delivery. This feature enables us to match supply and demand within this closed or semi-closed system. It also significantly reduces the cost of hydrogen storage by using non-productive assets that are unique to upstream production operations.

By “local” we generally mean within a given oil field or near thereto. Many basins have a great many oil fields in sufficiently close proximity as to make the transport of locally generated electricity or hydrogen economically feasible. Thus, in some cases where two or more oil fields are closely located, infrastructure may proceed from one field to a nearby field. Local transport is therefore <100 miles, preferably <50 miles, more preferred under 25 or 10 miles and most preferred within a 5, 4, 3, or 2 mile radius. Ideally, electricity is generated within a mile of its ultimate usage.

As used herein, “oil production equipment for producing hydrocarbons from said oil field” includes equipment for any and all pre- and post-production activities, such as fracking, as well as production activities which occur while oil is being produced.

As used herein, a “new oil well” is a well that is being drilled, completed, or otherwise is any well existing in that part of the life cycle that is prior to producing hydrocarbon.

As used herein a “producing oil well” is producing hydrocarbon.

As used herein a “non-producing oil well” is no longer producing hydrocarbon at an economical rate and can therefore be converted to an HSW.

Oil wells may cycle through these life cycle stages more than once, as economics changes and/or technology changes. Thus, an abandoned well can be reopened and become a producer if the price of oil increases sufficiently.

As used herein, a “hydrogen storage well” or “HSW” is a non-producing well that has been plugged at the top of the reservoir but retains the Christmas tree and is fitted or retrofitted with the required pressure sensors and pressure regulators, as well as any needed hardware for injecting hydrogen therein and for later delivering hydrogen as needed, together with all required or advisable safety equipment, such as alarms, leak detectors, and the like.

As used herein, “wind power” is wind energy to generate useful work usually via wind turbines—a device that converts the kinetic energy of wind into electrical energy. Herein, the wind turbine is used to provide electricity to run the electrolyzer.

As used herein, “solar power” is solar energy to generate useful work either directly using photovoltaics (PV) or indirectly using concentrated solar power. Herein, the solar panels are used to provide electricity to run the electrolyzer.

As used herein, “geothermal power” is the thermal energy in the earth that is produced by the formation of the planet, the molten core and by radioactive decay. Herein, it may also be possible to use the heat of the reservoir to generate electricity using dry steam power stations, flash steam power stations or binary cycle power stations. However, this is less preferred as we expect that the temporarily abandoned wells will already be in use for hydrogen storage and not available for geothermal access. However, in older plays with greater numbers of non-producing wells, geothermal power usage may be a viable option.

“Clean power” or “clean power sources” includes hydrogen, wind, solar, hydroelectric, and geothermal. In an offshore context, clean power may also include wave power. Machines that exploit wave power are called wave energy converters (WEC).

“Intermittent clean power” includes wind, solar, tidal, and other forms of clean energy that cycle in output.

“Clean hydrogen” means hydrogen produced with clean power, such as wind, solar, hydroelectric, WEC, or geothermal energy and is sometimes called “green hydrogen.” By contrast “gray hydrogen” is made from natural gas through steam methane reforming. “Black” or “brown” hydrogen is the most environmentally damaging as both the CO₂ and carbon monoxide generated during the process are not recaptured.

“Clean hydrogen” can also include “blue” hydrogen whenever the carbon generated from steam reforming is captured and stored underground through industrial carbon capture and storage (CSS). This could be used herein if CO₂ is injected into the reservoirs. For blue hydrogen to be useful, HSW should be sufficiently separated from the storage reservoir as to prevent contamination of the stored H₂S, although this may not present difficulties as long as the casings and plugs in the HSW remain intact.

As used herein an “electrolyzer” is a device that functions to electrically split water into hydrogen and oxygen. Electrolyzers consist of an anode and a cathode separated by an electrolyte. Different electrolyzers function in different ways, mainly due to the different type of electrolyte material involved and the ionic species it conducts.

In a polymer electrolyte membrane (PEM) electrolyzer, the electrolyte is a solid specialty plastic material. Water reacts at the anode to form oxygen and positively charged hydrogen ions (protons). The electrons flow through an external circuit and the hydrogen ions selectively move across the PEM to the cathode. At the cathode, hydrogen ions combine with electrons from the external circuit to form hydrogen gas. Since these are produced at opposite ends, they are easy to keep separate, and the H₂ can be routed to the HSW or H2P units, and the oxygen liquidated and sold or otherwise used.

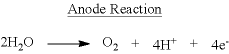

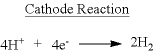

Alkaline electrolyzers (OH⁻ electrolyzers) operate via transport of hydroxide ions (OH⁻) through the electrolyte from the cathode to the anode with hydrogen being generated on the cathode side. Electrolyzers using a liquid alkaline solution of sodium or potassium hydroxide as the electrolyte have been commercially available for many years, but newer approaches using solid alkaline exchange membranes (AEM) are showing promise on lab scales.

Solid oxide electrolyzers (SOX electrolyzers) use a solid ceramic material as the electrolyte that selectively conducts negatively charged oxygen ions (O²⁻) at elevated temperatures and generate hydrogen in a slightly different way. Steam at the cathode combines with electrons from the external circuit to form hydrogen gas and negatively charged oxygen ions. The oxygen ions pass through the solid ceramic membrane and react at the anode to form oxygen gas and generate electrons for the external circuit.

SOX electrolyzers must operate at temperatures high enough for the solid oxide membranes to function properly (about 700°−800° C., compared to PEM electrolyzers, which operate at 70°−90° C., and OH⁻ electrolyzers, which typically operate at less than 100° C.). However, advanced lab-scale SOX electrolyzers based on proton-conducting ceramic electrolytes are showing promise for lowering the operating temperature to 500-600° C.

Given the high temperatures needed to operate SOX electrolyzers, we expect that that PEM, OH⁻ or AEM electrolyzers will be preferred. We also note that the heat needed herein may also be provided onsite by the produced oil, which will be hot, especially in steam stimulated reservoirs.

As used herein a “hydrogen-to-power unit” (“H2P”) or “hydrogen generator” is any device that can convert hydrogen back into electricity or other form of power. For example, gas turbine combusters can be modified for use with hydrogen fuel. Since hydrogen is one-third less dense than methane, three times the volume flow is required to provide the same energy input. The flame speed of hydrogen is one order of magnitude faster than methane—170 cm/s and 38.3 cm/s respectively. Thus, the gas turbine unit must be modified to account for these differences, but specially designed H₂ gas turbine units are commercially available and continue to be developed.

For example, General Electric has more than 120 hydrogen turbine units in operation. See e.g., the GE 7HA.03 combustion turbines capable of running on 50% hydrogen and the retrofittable F-class combustion systems capable of operation on 100% hydrogen using a combination of micro mixer and axial fuel staging technologies. Siemens Gas and Power is also developing turbines with 100% hydrogen capability, and all of its aeroderivative units outfitted with WLE systems based on diffusion burner technology already fulfill the target of 100% hydrogen capability.

The above reaction (burning hydrogen to make water) develops temperatures in the flame zone above 3,000° C. Therefore, additional water is injected so that the steam temperature can be regulated at a desired level. Both saturated and superheated vapor can thus be produced. This steam can then be routed downhole where needed for steam stimulation methods, or used in steam generation of power, resulting in even further efficiencies.

As one example, the German Aerospace Research Establishment has developed a compact hydrogen/oxygen steam generator (Sternfeld, 1989). The steam generator consists of the ignition, combustion, and evaporation chambers. In the ignition chamber a combustible mixture of hydrogen and oxygen at a low oxidant/fuel ratio is ignited by means of a sparkplug. The rest of oxygen is added in the combustion chamber to adjust the oxidant/fuel ratio exactly to the stoichiometric one. Water is also injected in the combustion chamber after it has passed through the double walls of the combustion chamber. The evaporation chamber serves to homogenize the steam. The steam's temperature is monitored and controlled. Such a device is close to 100% efficient since there are no emissions other than steam and little or no thermal losses.

Hydrogen and oxygen in presence of a suitable catalyst may be combined at temperatures significantly lower than flame combustion (from ambient to 500° C.) and this may be preferrable given the flammability of oil, gas and H₂. Catalytic hydrogen burners require considerably more surface area than conventional flame burners. Therefore, the catalyst is typically dispersed in a porous structure. The reaction rate and resulting temperature are easily controlled by controlling the hydrogen flow rate. The reaction takes place in a reaction zone of the porous catalytic sintered metal cylinders or plates in which hydrogen and oxygen are mixed by diffusion from opposite sides. A combustible mixture is formed only in the reaction zone and assisted with catalyst (typically platinum) to burn at low temperatures. The only product of catalytic combustion of hydrogen is water vapor. Due to the lower temperatures, no nitrogen oxides are formed. As an added benefit, the reaction cannot migrate into the hydrogen supply, since there is no flame and hydrogen concentration is above the higher flammable limit (75%). Catalytic burners may be preferred as posing less risk in an oil producing zone, but reverse electrolysis may be even more preferred.

Hydrogen can be combined with oxygen without combustion in the reverse of electrolysis and produce electricity (DC). The device where such a reaction takes place is called the “electrochemical fuel cell” or just “fuel cell.” Depending on the type of the electrolyte used, there are several types of fuel cells:

Alkaline fuel cells (AFC) use concentrated (85 wt. %) KOH as the electrolyte for high temperature operation (250° C.) and less concentrated (35-50 wt. %) for lower temperature operation (<120° C.). The electrolyte is retained in a matrix (usually asbestos), and a wide range of electrocatalysts can be used (such as Ni, Ag, metal oxides, and noble metals). This fuel cell, however, is intolerant to CO₂ present in either fuel or oxidant.

Polymer electrolyte membrane or proton exchange membrane fuel cells (PEMFC) use a thin polymer membrane (such as perfluorosulfonated acid polymer) as the electrolyte. Membranes as thin as 12-20 microns have been developed, which are excellent proton conductors. The catalyst is typically platinum with loadings about 0.3 mg/cm², or, if the hydrogen feed contains minute amounts of CO, Pt—Ru alloys are used. Operating temperature is usually below 100° C., more typically between 6° and 80° C.

Phosphoric acid fuel cells (PAFC), use concentrated phosphoric acid (˜100%) as the electrolyte. The matrix used to retain the acid is usually SiC, and the electrocatalyst in both the anode and cathode is platinum black. Operating temperature is typically between 150-220° C.

Molten carbonate fuel cells (MCFC) have an electrolyte composed of a combination of alkali (Li, Na, K) carbonates, which is held in a ceramic matrix of LiAlO₂. Operating temperatures are between 600-700° C. where the carbonates form a highly conductive molten salt, with carbonate ions providing ionic conduction. At such high operating temperatures, noble metal catalysts are typically not required.

Solid oxide fuel cells (SOFC) use a solid, nonporous metal oxide, usually Y₂O₃— stabilized ZrO₂ as the electrolyte. The cell operates at 900-1000° C. where ionic conduction by oxygen ions takes place.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed and excludes all additional elements.

The phrase “consisting essentially of” excludes additional material elements, but allows the inclusions of non-material elements, such as valving, piping, and the like, that do not substantially change the nature of the invention.

Any phrase introduced with the phrase “comprising” may be changed to “consisting of” or “consisting essentially of” and vice versa, but each claim is not repeated herein with each transition phrase in the interests of brevity.

The following abbreviations are used herein:

| ABBREVIATION | TERM |
|---|---|
| AEM | Alkaline exchange membranes |
| AFC | Alkaline fuel cells |
| CNG | Compressed Natural Gas |
| CSG | Cyclic steam generation |
| CSS | Cyclic steam stimulation |
| DC | Direct current |
| DLE | Dry low emissions combustion technologies. |
| E&P | Exploration and production [of hydrocarbons] |
| EOR | Enhanced oil recovery |
| EPDM | Ethylene Propylene Diene Monomer |
| ESD | Emergency Shutdown Device |
| fracking | Hydraulic fracturing |
| FRP | Fiber reinforced piping |
| H2P | Hydrogen-to-power |
| HDPE | High-density polyethylene |
| HSW | Hydrogen storage wells |
| ICE | Internal combustion engine |
| MCFC | Molten carbonate fuel cells |
| NBR | Nitrile rubber |
| NO_{X} | NO (Nitric oxide), NO₂ (Nitrogen dioxide); NO_{X} |
| | is a term for nitrogen oxides |
| Nylon 11 | Polyamide 11 |
| OH- | Hydroxide ions, Alkaline |
| P2H2P | Power-to-Hydrogen-to-Power |
| PAFC | Phosphoric acid fuel cells |
| PEM | Polymer electrolyte membrane |
| PEMFC | Polymer electrolyte membrane or proton exchange |
| | membrane fuel cells |
| POM | Polyoxymethylene |
| PPS | Polyphenylene sulfide |
| PTFE | Polytetrafluoroethylene |
| PV | Photovoltaic |
| SAGD | Steam assisted gravity drainage |
| SOFC | Solid oxide fuel cells |
| SOX | Solid oxide |
| TAW | Temporary abandoned well |
| Viton A | A family of fluoroelastomers that are dipolymers |
| | of hexafluoropropylene (HFP) and vinylidene |
| | fluoride (VF₂) |
| WEC | Wave energy converter |
| WLE | Wet low emissions combustion technologies |

### BRIEF DESCRIPTION OF THE DRAWINGS

FIG. 1. A simplified schematic of the H₂ ecosystem established in an oil field or basin for use in oil production. Pipelines and components are highly simplified herein for clarity.

FIG. 2. A schematic of the hydrogen ecosystem used for hydraulic fracturing.

FIG. 3A-C. Three options for refitting temporary abandoned wells for use as hydrogen storage wells.

FIG. 4A-B. A schematic of the hydrogen storage and delivery system.

### DETAILED DESCRIPTION OF THE INVENTION

The invention provides a novel hydrogen ecosystem for use in oil production that takes advantage of the large amounts of existing infrastructure to reduce costs and generate electricity where it is needed so that transmission losses are negligible. When available, intermittent clean electricity is used to generate H₂ by electrolysis, which is stored on-site in existing wells that are no longer producing and are instead converted over for hydrogen storage. Since such wells are typically cased, and are readily available on site, the storage problem is readily addressed, and hydrogen leakage is minimized.

When needed, the hydrogen is again converted to electricity using any of the available technologies, and the electricity used to power various oil production operations, such as drilling, steam injection, hydraulic fracking, and the like.

Preferably, existing pipelines are used for hydrogen transport, especially to and from hydrogen storage wells, but even where new piping may be needed, it can use existing right of ways, support structures, trenches, and the like. Since steel piping is used throughout oil and gas production, hydrogen leakage losses are minimal, and the system overall produces far less greenhouse gases that the current method of burning diesel, propane, or natural gas. Indeed, depending on the system of converting H₂ to electricity, the only gases produced will be a small amount of H₂ due to leakage, and possibly NOx. Furthermore, if a hydrogen steam generator is used to convert the hydrogen to electricity the co-generated steam can also be used on site, e.g., for steam stimulation of the reservoir in CSS or SAGD and related LOR methods. Steam can also be used to provide the water for electrolysis.

The invention includes any one or more of the following embodiments, in any combination(s) thereof:
A method of converting a non-producing well to a hydrogen storage well, said method comprising: a) plugging a cased non-producing well at a base thereof with cement plus optionally one or more plugs or packers at a top of a reservoir play; b) installing one or more pressure monitors to monitor well integrity unless already present; c) installing one or more high pressure injection valves for injecting high pressure hydrogen into said well unless already present; d) installing one or more pressure reducing regulators for producing uncompressed hydrogen; e) said hydrogen storage well able to store hydrogen from a top of said hydrogen storage well to said cement.
A method of converting a non-producing well to a hydrogen storage well, said method comprising: a) plugging a non-producing well with cement plus optionally one or more plugs or packers at a top of a reservoir play; b) installing a rigid or expandable liner that retains 99% of hydrogen into said non-producing well; c) installing one or more pressure monitors to monitor well integrity unless already present; d) installing one or more high pressure injection valves for injecting high pressure hydrogen into said well unless already present; e) installing one or more pressure reducing regulators for producing uncompressed hydrogen; f) said hydrogen storage well able to store hydrogen from a top of said hydrogen storage well to said cement plus optionally one or more plugs or packers.

Any method herein described, said method preceded by hanging an interior casing in a non-producing well, thereby providing said cased non-producing well.

Any method herein described, further comprising installing a hydrogen leak detection and alarm system on said non-producing well.
A clean energy system for producing oil and gas, said system comprising: a) one or more producing oil wells, one or more non-producing oil wells, and optionally one or more new wells; b) a H₂ source fluidly connected to a compressor for producing compressed hydrogen; c) said compressor fluidly connected to a high-pressure injection line for injecting said compressed hydrogen into a hydrogen storage well (HSW), said HSW being a vertical portion of a non-producing well that has been plugged at a top of a reservoir play and re-fitted for pressure monitoring and hydrogen storage; d) said HSW fluidly connected to a pressure reducing regulator for producing uncompressed hydrogen; e) said pressure reducing regulator fluidly connected to a pipeline for delivering said uncompressed hydrogen to a hydrogen-to-power unit for converting said uncompressed hydrogen to clean electricity; f) said clean electricity electrically connected to oil production equipment for producing hydrocarbons from said producing oil wells.
A clean energy system for producing oil and gas, said system comprising: a) one or more producing oil wells, one or more non-producing oil wells, and optionally one or more new wells; b) an electricity source electrically connected to an electrolyzer for converting water to hydrogen; c) said electrolyzer fluidly connected to a compressor for producing compressed hydrogen; d) said compressor fluidly connected to a high-pressure injection line for injecting said compressed hydrogen into a hydrogen storage well (HSW), said HSW being a vertical portion of a non-producing well that has been plugged at a top of a reservoir play and re-fitted for pressure monitoring and hydrogen storage; e) said HSW fluidly connected to a pressure reducing regulator for producing uncompressed hydrogen; f) said pressure reducing regulator fluidly connected to a pipeline for delivering said uncompressed hydrogen to a hydrogen-to-power unit for converting said uncompressed hydrogen to clean electricity; g) said clean electricity electrically connected to oil production equipment for producing hydrocarbons from said producing oil wells.
A clean energy system for producing oil and gas, said system comprising: a) one or more producing oil wells, one or more non-producing oil wells, and optionally one or more new wells; b) a wind farm or a solar farm, or both, for generating electricity; c) said wind farm or a solar farm, or both, electrically connected to an electrolyzer for converting water to hydrogen; d) said electrolyzer fluidly connected to a compressor for producing compressed hydrogen; e) said compressor fluidly connected to a high-pressure injection line for injecting said compressed hydrogen into a hydrogen storage well (HSW), said HSW being a vertical portion of a non-producing well that has been plugged at a top of a play and re-fitted for pressure monitoring and hydrogen storage; f) said HSW fluidly connected to a pressure reducing regulator for producing uncompressed hydrogen; g) said pressure reducing regulator fluidly connected to a pipeline for delivering said uncompressed hydrogen to a hydrogen-to-power unit for converting said uncompressed hydrogen to electricity; h) said electricity electrically connected to oil production equipment for producing hydrocarbons from said producing oil wells.

Any method or system herein described, wherein said hydrogen-to-power unit is selected from a hydrogen turbine generator, a mixed hydrogen/methane turbine generator, a hydrogen steam generator, a mixed a hydrogen/methane steam generator, a catalytic burner turbine generator, a reverse electrolysis unit, one or more fuel cells, and combinations thereof.

Any method or system herein described, wherein said hydrogen-to-power unit is one or more fuel cells.

Any method or system herein described, wherein said hydrogen-to-power unit is a hydrogen steam generator and at least a portion of steam produced by said hydrogen steam generator is fed into an electrolyzer or said electrolyzer for conversion to said hydrogen and O₂.

Any method or system herein described, wherein said pipeline is one or more of an existing pipeline from said one or more non-producing oil wells, or a new gas pipeline laid alongside production piping from said producing oil wells or an unused pipeline from said one or more new wells before use in production from said new oil wells.

Any method or system herein described, wherein said clean electricity is used for hydraulic fracturing.

Any method or system herein described, wherein said clean electricity is used for steam generation.

Any method system herein described, wherein said hydrogen-to-power unit is a hydrogen steam generator and said clean electricity is used for steam generation.

Any method or system herein described, wherein said compressed hydrogen is at about 5,000-10,000 psig or about 8,000 psig and said uncompressed hydrogen is less than 500 psig or less than about 275 psig.

Any method or system herein described, wherein said electricity source is wind power or solar power or both.

Any method or system herein described, wherein said electricity source is wind power or solar power or both and said electricity source is within 10 miles of said oil production equipment.

Any method or system herein described, wherein said electrolyzer is selected from a polymer electrolyte membrane electrolyzer, an alkaline electrolyzer, a solid alkaline exchange membranes electrolyzer, or a solid oxide electrolyzer.

Any method or system herein described, wherein said pipeline is a fiber reinforced polymer (FRP) pipeline.

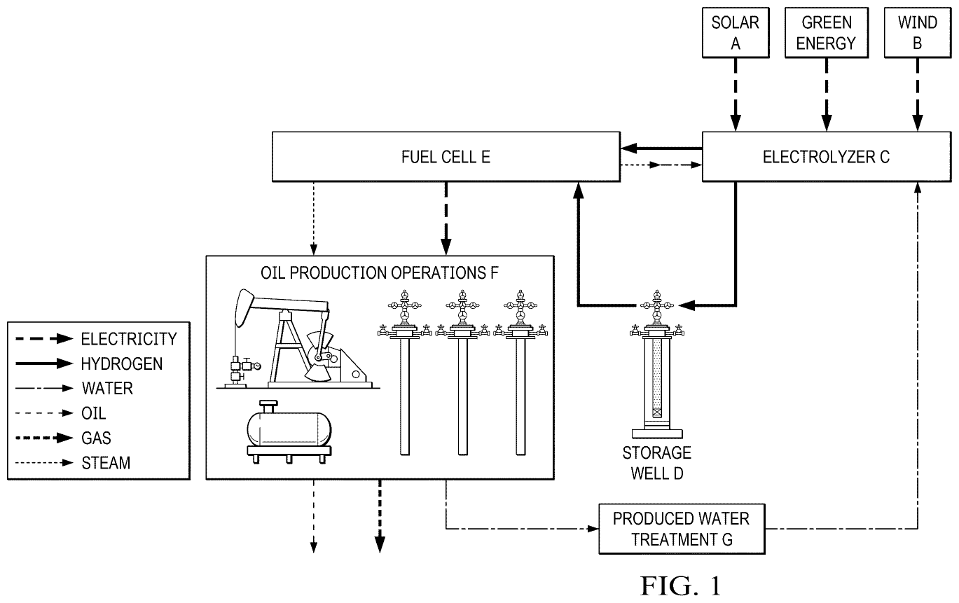

FIG. 1 shows a simplified schematic of the H₂ ecosystem, wherein pipelines, pressure components, valving, and the like, are simplified and/or omitted for clarity. All components of FIG. 1 are either on-site in a single oil field, or brought in locally from nearby fields, but we will assume for the purposes of this discussion that all components are on-site.

The ecosystem starts with a solar farm A and/or a wind farm B (preferably both) which generate electricity when wind or sun is available. The electricity powers electrolyzer C to separate H₂ from water. The hydrogen is then piped and compressed into a non-producing well D which has been converted to a hydrogen storage well or “HSW.” The H₂ is stored there at high pressures until needed. If the hydrogen is to be used right away, it may bypass the HSW and route straight to the fuel cell E. Fuel cell E is only one option, and E could alternatively be a hydrogen turbine, a hydrogen/methane turbine, a reverse electrolyzer, a hydrogen steam generator, a catalytic burner and the like. The electricity is then used for various oil field operations F and ultimately, oil, gas and water are produced. The produced water is purified at the produced water treatment unit G, and can then be reused in operations F or even routed to electrolyzer C.

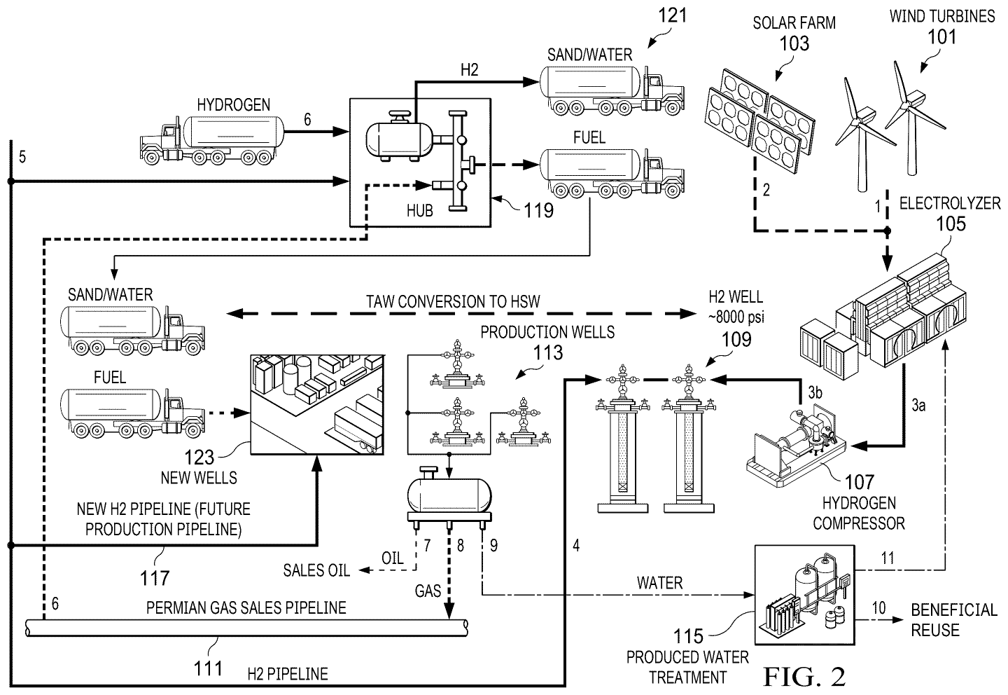

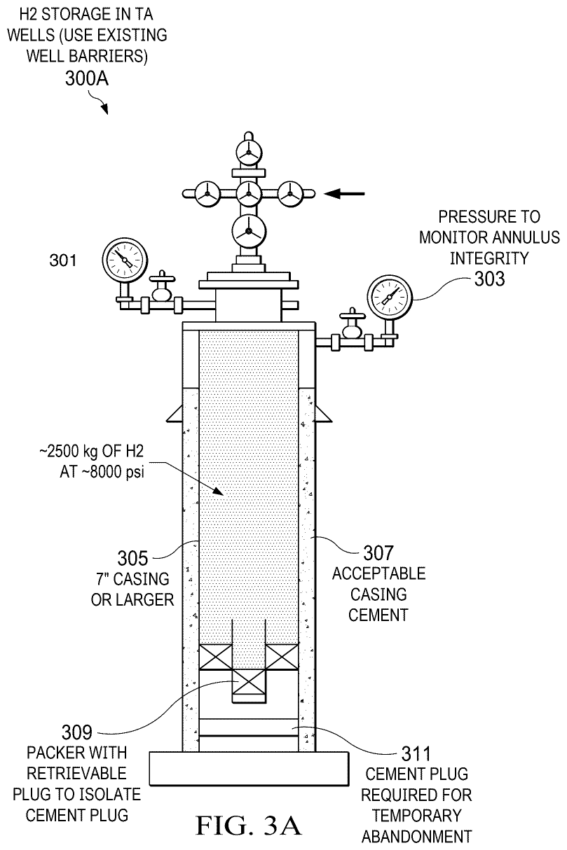

FIG. 2 shows an embodiment of the hydrogen ecosystem used for fracking, wherein solar farm 103 is on site at the oil field. Wind turbines 101 may be on the oil field, and operator owned, or wind power may be purchased from a relatively nearby farm, for example in west Texas where there are significant wind farms owned by power companies. Electric lines 1 and 2 feed power to electrolyzer 105 and convert water to H₂ which feeds via line 3a to hydrogen compressor 107, and from there via high pressure line 3b to hydrogen storage wells 109 where the H₂ is stored as a compressed gas at about 8,000 psig or about 5,000-10,000 psig.

When fracking is needed for new wells, H₂ is sent via H₂ line 4 directly to the frac site via new H₂ pipeline 117 or to the fuel hub 119, where it is blended with produced gas (if a H₂/CNG blend is used as fuel) and transported by trucks 121 to the frac site to feed generators to power electric frac pumps. Hydrogen may also be brought in by truck 6 or piped in from nearby fields via line 5. High pressure fluid is pumped into new wells 123 at a pressure exceeding the fracture pressure of the rock, and there after sand and fluid 121 are pumped into the reservoir to prop open the fractures. Trucks 121 delivering water, sand, H₂ or H₂/CNG blend can be also powered by hydrogen in Hub 119.

After fracking, the wells are converted to production wells 113 and produce oil via line 7, gas via 8 and water via 9. Oil is usually routed to sale and/or trucks or other transport means via line 7. The gas 8 may enter a pipeline 111 for sale or may be routed to hub 119 via line 6. Produced water may be routed via line 9 to produced water purifier 115 and then routed 10 for reuse in operations, or if clean enough may be routed via 11 to electrolyzer 105.

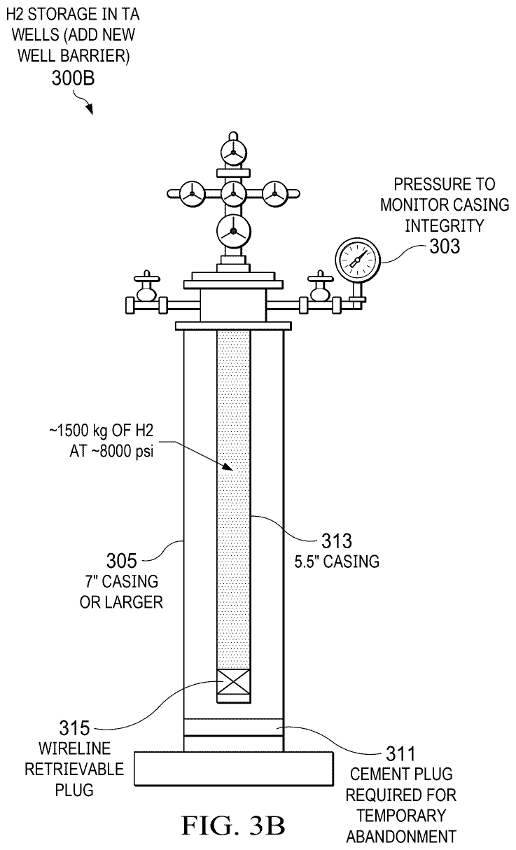

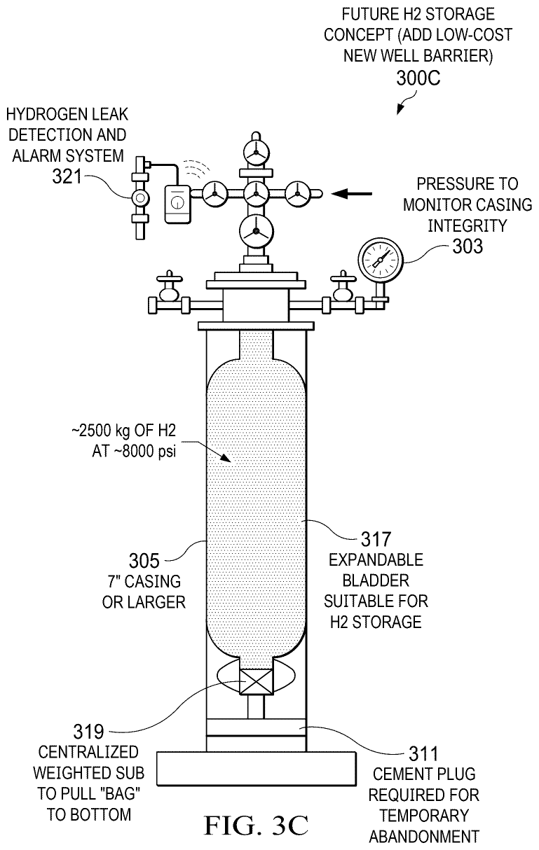

FIG. 3 shows three options for converting a TAW to an HSW. In 300A in FIG. 3A, we use the existing barriers, including cement plug 311 (required to abandon a well), casing 305 which is preferably at least 7″, cemented annulus and the usual packers and/or retrievable plugs 309 that are typically used to isolate the cement plug 311. Pressure monitor 301 is installed (if not already present) on the wellhead to monitor casing integrity, and a second pressure monitor 303 installed in the annulus also helps to monitor casing integrity. In a well of this type with a casing of 7″ it is possible to store about 2500 kg of H₂ at 8000 psi. Casings may be lined with a latex, PVC, multilayer mylar, or other bladder (307). Bladder surfaces may be coated to resist hydrogen escape and/or resist reservoir conditions including hydrocarbons and acidic environment.

FIG. 3B shows 300B, where the existing cement or casing is insufficient to task, a new casing 313 is hung with wireline retrievable plug 315. In 300C, shown in FIG. 3C, we envision developing either a rigid liner or an expandable bladder 317 for H₂ storage, the bladder equipped with a centralized weight sub 319 to pull the flexible bag to the bottom.

It is true that hydrogen tends to escape from most polymeric materials. However, high density polymeric liners have been developed to line hydrogen vessels and present opportunities for development as flexible bladders and/or rigid liners. For example, fiber reinforced piping (FRP) liner materials have been developed for hydrogen storage, and the commercial pipeline materials of most interest are Fiberspar® and Poly-Flow. The liner in Fiberspar® (NOV Inc., TX) is a commercial high-density polyethylene (HDPE) with an inner thermoplastic pressure barrier reinforced by high-strength glass fibers embedded in an epoxy matrix. Poly-Flow® (Poly-Flow LLC, OR) is polyphenylene sulfide (PPS). Further, this is an area of intense interest, and researchers are developing models, test procedures, and safety protocols, and are actively testing polymers such as NBR, EPDM, PTFE, Nylon-11, POM, Viton A and the like for hydrogen storage. In addition, a polymer may be coated with foil to reduce hydrogen leakage.

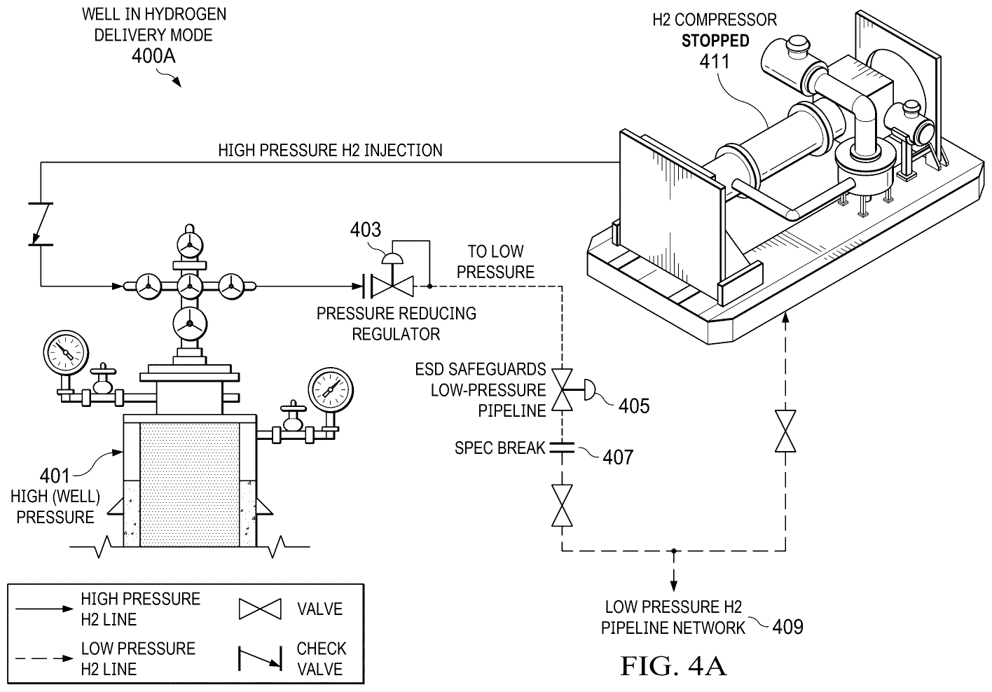

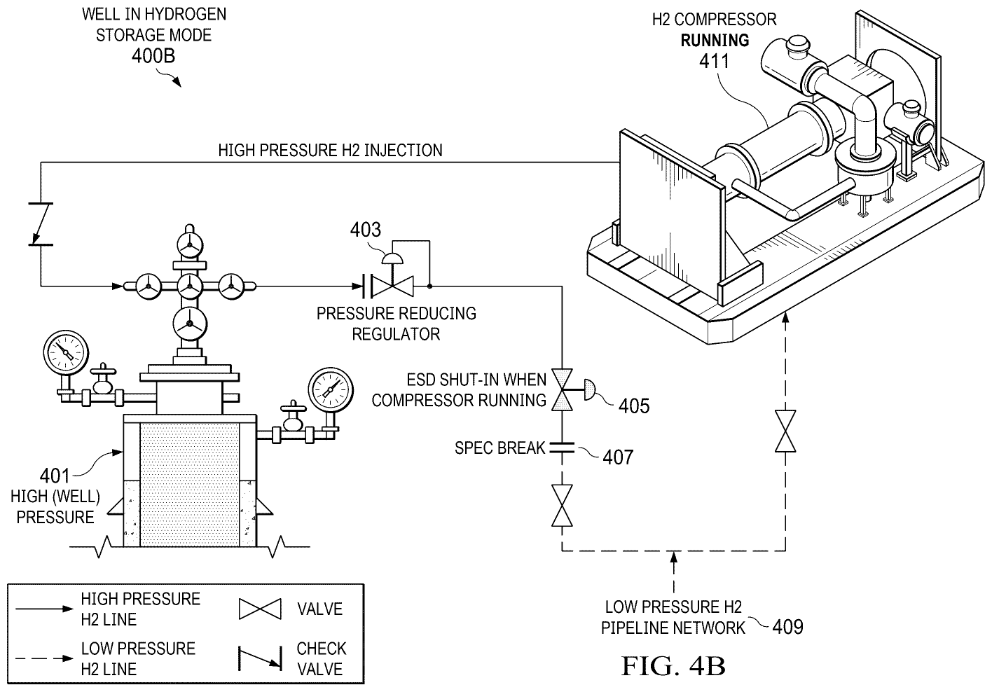

FIG. 4 shows the hydrogen storage and delivery system. In 400A, shown in FIG. 4A, the system is in delivery mode, wherein compressor 411 is stopped, hydrogen is sent from the HSW 401 to pressure reducing regulator 403, which reduces the hydrogen from the 8000 psi in the well to <500 psig, and preferably about 275 psig or less for transport. 407 is the spec break (allowing for a change in the piping design specifications). The emergency shutdown device or “ESD” 405 safeguards the low-pressure pipeline 409 for delivery to operations.

In 400B in FIG. 4B, the low-pressure pipeline 409 inputs H₂ to the compressor 411 which is now running. This is not necessarily the outgoing H₂ line but could be a separate line. Compressor 411 compresses the H₂ for injection into the HSW 401. ESD 405 is shut off during H₂ storage to force high pressure injection to the well and preventing diversion to the low-pressure line.

The following references are incorporated by reference in their entirety for all purposes.
U.S. Ser. No. 12/066,012 Heat-harvesting of end-of-life wells.
Sternfeld, H. J.; Heinrich, P. “A demonstration plant for the hydrogen/oxygen spinning reserve.” Int. J. Hydrogen Energy, Vol. 14, pp. 703-716, 1989.

1) A clean energy system for producing oil and gas, said system comprising:
a) one or more producing oil wells, one or more non-producing oil wells, and optionally one or more new wells;
b) an H₂ source fluidly connected to a compressor for producing compressed hydrogen;
c) said compressor fluidly connected to a high-pressure injection line for injecting said compressed hydrogen into a hydrogen storage well (HSW), said HSW being a vertical portion of a non-producing well that has been plugged at a top of a reservoir play and re-fitted for pressure monitoring and hydrogen storage;
d) said HSW fluidly connected to a pressure reducing regulator for producing uncompressed hydrogen;
e) said pressure reducing regulator fluidly connected to a pipeline for delivering said uncompressed hydrogen to a hydrogen-to-power unit for converting said uncompressed hydrogen to clean electricity;
f) said clean electricity electrically connected to oil production equipment for producing hydrocarbons from said producing oil wells.

2) The system of claim 1, said system further comprising:
a) an electricity source electrically connected to an electrolyzer for converting water to hydrogen;
b) said electrolyzer fluidly connected to a compressor for producing compressed hydrogen;
c) said compressor fluidly connected to a high-pressure injection line for injecting said compressed hydrogen into said HSW.

3) The system of claim 2, said system further comprising:
a) a wind farm or a solar farm, or both, for generating electricity;
b) said wind farm or a solar farm, or both, electrically connected to said electrolyzer.

4) The system of claim 1, wherein said hydrogen-to-power unit is selected from a hydrogen turbine generator, a mixed hydrogen/methane turbine generator, a hydrogen steam generator, a mixed hydrogen/methane steam generator, a catalytic burner turbine generator, a reverse electrolysis unit, one or more fuel cells, and combinations thereof.

5) The system of claim 1, wherein said hydrogen-to-power unit is one or more fuel cells.

6) The system of claim 1, wherein said hydrogen-to-power unit is a hydrogen steam generator and at least a portion of steam produced by said hydrogen steam generator is fed into an electrolyzer or said electrolyzer for conversion to said hydrogen and O₂.

7) The system of claim 1, wherein said pipeline is one or more of an existing pipeline from said one or more non-producing oil wells, or a new gas pipeline laid alongside production piping from said producing oil wells or an unused pipeline from said one or more new wells before use in production from said new oil wells.

8) The system of claim 1, wherein said clean electricity is used for hydraulic fracturing or for steam generation or for both hydraulic fracturing and steam generation.

9) The system of claim 1, wherein said hydrogen-to-power unit is a hydrogen steam generator and said clean electricity is used for steam generation.

10) The system of claim 1, wherein said compressed hydrogen is at about 5,000-10,000 psig or about 8,000 psig and said uncompressed hydrogen is less than 500 psig or less than about 275 psig.

11) The system of claim 2, wherein said electricity source is wind power or solar power or both.

12) The system of claim 2, wherein said electricity source is wind power or solar power or both and said electricity source is within 10 miles of said oil production equipment.

13) The system of claim 2, wherein said electrolyzer is selected from a polymer electrolyte membrane electrolyzer, an alkaline electrolyzer, a solid alkaline exchange membranes electrolyzer, or a solid oxide electrolyzer.

14) The system of claim 2, wherein said pipeline is one or more of an existing pipeline from said one or more non-producing oil wells, or a new gas pipeline laid alongside production piping from said producing oil wells or an unused pipeline from said one or more new wells before use in production from said producing oil wells.

15) The system of claim 2, wherein said clean electricity is used for hydraulic fracturing or for steam generation or for both hydraulic fracturing and steam generation.

16) The system of claim 2, wherein said hydrogen-to-power unit is a hydrogen steam generator and said clean electricity is used for steam generation.

17) The system of claim 1, wherein said pipeline is a fiber reinforced polymer (FRP) pipeline.

18) A method of converting a non-producing well to a hydrogen storage well, said method comprising:
i) plugging a cased non-producing well at a base thereof with cement plus optionally one or more plugs or packers at a top of a reservoir play;
ii) installing one or more pressure monitors to monitor well integrity unless already present;
iii) installing one or more high pressure injection valves for injecting high pressure hydrogen into said well unless already present;
iv) installing one or more pressure reducing regulators for producing uncompressed hydrogen;
v) said hydrogen storage well able to store hydrogen from a top of said hydrogen storage well to said cement.

19) The method of claim 18, said method preceded by hanging an interior casing in a non-producing well, thereby providing said cased non-producing well.

20) A method of converting a non-producing well to a hydrogen storage well, said method comprising:
i) plugging a non-producing well with cement plus optionally one or more plugs or packers at a top of a reservoir play;
ii) installing a rigid or expandable liner that retains 99% of hydrogen into said non-producing well;
iii) installing one or more pressure monitors to monitor well integrity unless already present;
iv) installing one or more high pressure injection valves for injecting high pressure hydrogen into said well unless already present;
v) installing one or more pressure reducing regulators for producing uncompressed hydrogen;
vi) said hydrogen storage well able to store hydrogen from a top of said hydrogen storage well to said cement plus optionally one or more plugs or packers.

21) The method of claim 20, further comprising installing a hydrogen leak detection and alarm system on said non-producing well.
